(19) United States
(12) Patent Application Publication
(10) Pub. No.: US 2009/0231594 A1
(43) Pub. Date: Sep. 17, 2009

(54) COMPONENT MOUNTING IN MOVEMENT-SENSITIVE EQUIPMENT

(75) Inventor: Paul George Harris, Suffolk (GB)

Correspondence Address: SUGHRUE MION, PLLC, 2100 PENNSYLVANIA AVENUE, N.W., SUITE 800, WASHINGTON, DC, 20037, US

(73) Assignee: VISTEC LITHOGRAPHY INC., Watervliet, NY (US)

(21) Appl. No.: 12/513,796

(22) PCT Filed: Nov. 8, 2007
(86) PCT No.: PCT/GB2007/004282

§ 371 Date: May 6, 2009

(30) Foreign Application Priority Data
Nov. 9, 2006 (GB) 0622362.2

(51) Int. Cl. G01B 11/14; G01B 9/02

(52) U.S. Cl. 356/500

(57) ABSTRACT

Movement-sensitive equipment (10), for example an electron beam lithography machine, is provided with an optical measuring system operable to measure the position of the equipment in a reference plane (A) so as to detect unintended displacement of the equipment in that plane, for example thermally induced shift of the lower end of an otherwise fixed electron beam column (11) of such a lithography machine. The system comprises an integral plate (17) of vitreous material provided with two mutually orthogonal reflective faces (19), with high optical accuracy, for reflecting laser or other measuring light beams. The plate (17) is adjustably and releasably mounted on the equipment (10) by a plurality of mounts (17) which permit accurate setting of the faces (19) relative to the plane (A) and allow removal of the plate as desired. The mounts (17) are designed to clamp the plate (17) in such a way as to avoid creation of stresses potentially causing cracks.

The present invention relates to movement-sensitive equipment and has particular reference to component mounting, especially mounting of a measuring system component, in the equipment.

Movement-sensitive equipment takes many forms, such as measuring apparatus of diverse kinds, machine tools for a wide range of purposes and equipment for processing and treating materials and articles in various ways. An example of equipment of that kind is an electron beam lithography machine, which is employed inter alia to write finally detailed patterns, such as integrated circuits, on suitable workpieces by the action of a focussed electron beam defining a beam writing spot. The writing spot traces pattern features through controlled deflection of the beam and periodic horizontal displacement of the workpiece. The workpiece, for example a semiconductor substrate or more commonly a mask as an intermediate element in generation of the pattern on such a substrate, is carried by a stage movable in at least one axial direction, normally in two orthogonal (X and Y) axial directions. Conventionally, the stage displacement is carried out to position the beam writing spot successively in different regions of the workpiece corresponding with individual zones or main fields of the pattern and the beam deflection is carried out to cause the writing spot to trace pattern features of successive subfields of each main field. The stage displacement and beam deflection are subject to close tolerances—currently in the nanometre range—determined by laser interferometry measuring systems for detecting stage horizontal position and by precise software control of electromagnetic beam deflecting coils. The machine as a whole is highly sensitive to changes in critical dimensions and to disturbances such as vibration and incorporates suitable measures to counteract or minimise the effect of such changes and disturbances.

Notwithstanding the various corrective measures undertaken in existing electron beam lithography machines, errors in beam orientation and thus writing spot placement can arise due to unintended change in location of the column position. The column is a solid, rigidly mounted structure, but has a substantial mass and is inevitably effected by, in particular, expansion and contraction of body components as a consequence of temperature change. As a result, the column as a whole or a major part of the column may be liable to displacement which effectively shifts all or part of the beam axis relative to a given reference point, in particular a notional point on a substrate assumed to have a fixed relationship with the beam axis in a horizontal sense. If the relationship is not fixed, but subject to periodic variation even if only in the nanometre range, writing precision can be adversely affected when highly accurate patterns or other such subject matter are involved. Similar difficulties can arise in connection with other types of movement-sensitive equipment, particularly when the accuracy of the equipment largely depends on reference axes which are assumed to be—but in reality are not—stable and unvarying in position.

It is therefore an object of the present invention to provide, in movement-sensitive equipment, measures for detection of a specific undesired shift in equipment position due to thermal or other internal or external influences, but without imposing a permanent restriction on access to the equipment for maintenance.

A further object of the invention in the case of such equipment is to provide scope for adjustment of a measuring system employed for such a detection purpose so as to enhance detection accuracy and allow repeatable setting of a system main component after disturbance of its position.

According to the present invention there is provided movement-sensitive equipment provided with an optical measuring system operable to measure the position of the equipment in a reference plane so as to detect unintended displacement of the equipment in that plane, the optical measuring system including an integral member of vitreous material provided with a plurality of reflective faces for reflecting measuring light beams and a plurality of mounts adjustably and releasably mounting the member on the equipment substantially in the reference plane.

The inclusion in the equipment of an optical measuring system utilising a member of vitreous material—thus a member with a significant degree of inherent stiffness and preferably with a substantially zero coefficient of expansion at room temperature—provided with reflective faces for optical measuring beams forms a basis for highly accurate measurement of unintended displacement, for example due to thermally induced expansion or contraction, of equipment or an equipment part intended to be immovable. However, such a member, preferably in the form of a plate, is not only fragile and thus susceptible to cracking, but also represents a potentially problematic intrusion into an equipment area which is sensitive with respect to availability of space and access for maintenance. These difficulties are largely avoided by use of mounts which mount the member to be adjustable, so that the reflective faces can be precisely aligned with the axes of the optical measuring beams, and also removable to allow access to the equipment for maintenance purposes. Maintenance in the case of the example of an electron beam lithography machine can be servicing, removal of or replacement of final lenses or other functional components which require periodic attention. In addition, the mounts can be designed to avoid application to the member of pressures liable to induce stresses which may cause cracks.

Preferably the mounts are adjustable in the sense of achieving orthogonality of the reflective faces relative to the reference plane. This allows accurate adjustment of the member not only at the time of initial setting up of the equipment, but also on each occasion the member is removed and refitted in connection with maintenance of the equipment. The achievable orthogonality can have a tolerance of, for example, substantially 5 microns, which is achievable by provision of suitably fine adjustment travels. In addition, the member is preferably mounted on the equipment to be rotationally adjustable in the reference plane in the sense of achieving perpendicularly of the reflective faces relative to axes of the light beams. Such an adjustment, which may in practice be very small, for example in the order of half a degree within a range such as ±one degree, permits setting of precise perpendicularity of the reflective faces to the light beams, particularly if necessary to compensate for shift in the beam axes due to, for example, thermally induced displacement of the beam sources.

For preference, three such mounts are provided at substantially equal spacings around a periphery of the member, three representing the optimum number for stable location of the member, ease of adjustment and minimum cost and complication. The combination of an intrinsically stiff member, such as a plate, of vitreous material with three equidistantly spaced mounts creates a rigid system able to resist mechanically sourced disturbances.

With advantage, each of the mounts fixes the member in position by clamping, preferably with a direction of clamping action oriented substantially exclusively perpendicularly to the reference plane. In the case of a member in the form of a plate, since the plate restraining forces act transversely through the plate between major faces thereof the creation of stress in the vitreous material of the plate is minimised and thus the risk of cracking of the plate. Even if stresses were to be established that did not actually cause cracks, thermal excursion could lead to stress redistribution and relative movement and thus ultimately represent a source of measuring error; the specified clamping action of the mounts largely eliminates that risk. In this connection each of the mounts can have substantially linear or punctiform contact with the member and preferably also with the equipment in the region of each mount. Such linear contact can be provided by a part-cylindrical surface and the punctiform contact by a part-spherical surface. An arrangement of this kind provides particularly precise location of the member and a capability of setting within the required fine tolerance range.

In order to minimise stress in the member at the locations of action of the mounts the member is preferably provided with a plurality of inserts each co-operable with a respectively associated one of the mounts and each having a greater resistance to fracture than the vitreous material. The higher-strength inserts thus accept the clamping or other fixing force exerted by the mounts and pass on the force to the equipment without the fragile vitreous material of the member being directly loaded. Each of the inserts can comprise a sleeve fixed in the member, for example by gluing, and a bearing element mounted in the sleeve to be adjustable substantially perpendicularly to the reference plane and arranged to bear against the associated mount. The adjustability of the bearing element in the sleeve is preferably achieved by threaded interengagement thereof so that the bearing element is adjustable in simple manner by rotation. The bearing element itself is preferably additionally arranged to bear against a respectively associated seat at the base of the equipment. An adjusted position of the bearing element in the sleeve can be fixed by a locknut or other simple locking means. With advantage, one of the seats is rotatable to impart to the associated bearing element a force tending to rotate the member of vitreous material in the reference plane, whereby the afore-mentioned rotation of the member for setting the perpendicularity of the reflective faces to the measuring light beam axes may be achieved in simple manner.

Avoidance of transmission of stress-inducing forces to the vitreous material member and provision of a capability for highly precise adjustment of the member can be achieved by design of each mount to allow freedom of movement about more than one axis. In a particularly effective embodiment each mount comprises two adjustable members each pivotable about a respective one of two substantially mutually orthogonal axes which are substantially parallel to the reference plane. The mounts thus function quasi in the manner of universal joints to accommodate tilt of the vitreous material member in all directions, in particular tilt arising from vertical adjustment of one or more of the bearing elements in the respective sleeve or sleeves. In that case, one of those two adjustable members of each mount can be arranged to be co-operable with the vitreous material member and to have an axis of pivotation extending substantially radially with respect to the centre thereof. The adjustable members with the substantially radial axes of pivotation are thus able to swivel without mutual conflict when movement is necessary to accommodate a change in orientation of the vitreous material member. The latitude necessary to accommodate such change is preferably achieved by allowing those adjustable members to be freely pivotable about their substantially radial axes of pivotation.

Preferably, the other one of the two adjustable members of each mount is attached to a fixing member of the mount to be pivotable about its respective axis of rotation. Such a fixing member may be fixed to the base of the equipment a short distance outboard of the member of vitreous material.

By contrast to the free mobility of the adjustable member pivotable about an axis substantially radial to the centre of the vitreous material member, the other adjustable member can be located in an adjusted position relative to the mount fixing member by position determining means determining that position, in particular a threaded adjuster operable to cause or allow pivotation of that other adjustable member about its axis of pivotation. The threaded adjuster can also be releasable to permit pivotation of the associated adjustable member to such an extent as to allow release of the vitreous material member, which may be of substantial importance from the viewpoint of access to the area above that member to enable maintenance or replacement of equipment components. In the case of an electron beam lithography machine, for example, electronic components disposed directly above the vitreous material member in the electron beam column of the machine will have to be periodically accessed for servicing and this will necessitate release and removal of the member, a procedure facilitated by construction of the mounts in the described preferred form with a threaded adjuster releasable to allow the adjustable members of the mounts to, for example, drop down away from the member. It is equally important that when the vitreous material member is remounted it can be returned to its original position, which, in a preferred construction of the mounts, can be conveniently achieved if each of the mounts incorporates an adjustable datum pin for recording the specific setting, which is determined by the threaded adjuster, of the adjustable member attached to the fixing member. Thus, for example, the datum pins can be set to register the position of adjustable components of the mounts, in particular the components releasable to allow removal of the vitreous material member, before their release so that the components can be more easily returned to their previous settings. This positional repeatability is of considerable importance for returning the equipment, specifically the reflective faces of its optical measuring system, to optimum orientations after maintenance. Laborious adjustment to recover these settings may thus be avoided or reduced to, at the most, fine final movement of the threaded adjusters to restore the exact settings.

In the optical measuring system the two reflective faces are preferably mutually orthogonal, thus able to be associated with X and Y axes. Such faces, when machined onto the member of vitreous material, can be optically flat to a tolerance of λ/10 so as to provide a basis for a highly accurate measuring system employing lasers to provide the measuring light beams. Such lasers can be incorporated in, for example, a laser interferometry measuring system.

The movement-sensitive equipment according to the invention can, as mentioned in the introduction, take various forms, one specific example of which is an electron beam lithography machine in which the reference plane will be at the base of an electron beam column of the machine and extend perpendicularly to the column axis. The invention is equally applicable to other machines such as those in which a stationary superstructure—which is nevertheless susceptible to undesired movement—with functioning components is located largely or entirely above a reference plane in which machining or another form of processing is carried out.

A preferred embodiment of the present invention will now be more particularly described by way of example with reference to the accompanying drawings, in which:

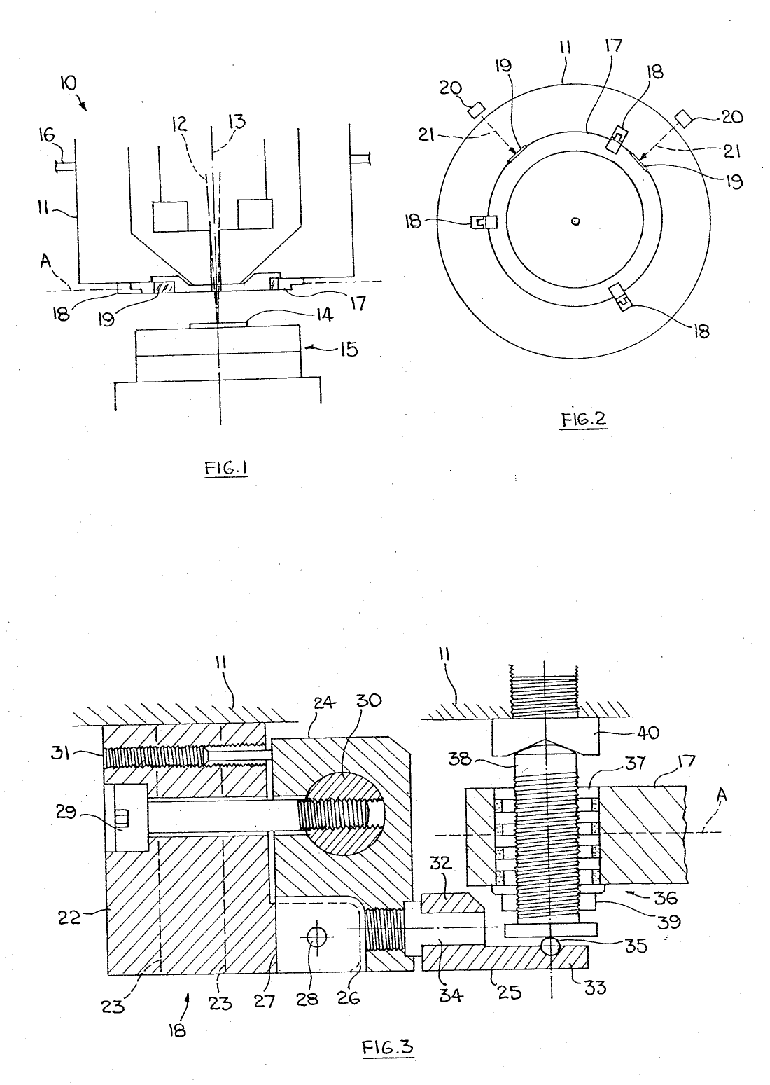

FIG. 1 is a schematic elevation of the base region of an electron beam column of an electron beam lithography machine embodying the invention;

FIG. 2 is a schematic inverted plan view of components of an optical measuring system associated with the underside of the column of the machine of FIG. 1; and

FIG. 3 is a schematic sectional elevation of a mount of the system, the mount clamping a mirror plate to the underside of the column.

Referring now to the drawings there is shown in FIG. 1, as an example of movement-sensitive equipment to which the invention is applicable, part of an electron beam lithography machine which can be used for inter alia writing integrated circuit patterns or other finely detailed patterns on a substrate. For this purpose the machine 10 comprises an electron beam column 11 (only the lower end is shown in FIG. 1) in which an electron beam 12 is generated to propagate along an axis 13 of the column to act on a substrate 14 mounted below the column on a movable stage 15. The substrate and stage are located in a vacuum chamber, the upper terminating wall of which is schematically indicated at 16. Writing is carried out by deflecting the electron beam 12 relative to the axis 13 to scan pattern features on the substrate 14 by a focussed beam spot and periodic movement of the stage 15 to locate successive regions, corresponding with parts of the pattern, of the substrate in the zone of writing action of the beam spot. The stage movement is usually in two mutually orthogonal horizontal directions, thus along X and Y axes of an X and Y co-ordinate system with the column axis 13 assumed to be invariably located at the origin.

Although the stage movement is undertaken on the basis of the axis 13 as an invariable datum it is entirely possible, as explained in the introduction, for an unintended, thermally induced displacement of the otherwise fixed column to shift this datum. This shift can lead to a degree of falsification of the co-ordinate system associated with the stage movement and consequently a displacement of the pattern position on the substrate 14 or, if the datum shift occurs during writing, a possible misalignment of fine pattern features or other reduction in writing accuracy. In order to detect any shift of this datum and thus obtain data for use in correcting machine operation, for example the beam deflection or the stage movement, an optical measuring system is provided for measuring the instantaneous column position in the zone of issue of the beam at the lower end of the column, in particular by detecting movement, in a reference plane A in this region, of the column axis relative to the assumed invariable position it occupies at the origin of the stage X and Y co-ordinate system. The reference plane A is selected to be approximately co-planar with a final lens aperture (not shown) in the lower end region of the column.

As shown in FIGS. 1 and 2, the optical measuring system comprises an integral plate 17 of vitreous material with a substantially zero coefficient of thermal expansion, for example the well-known Zerodur® glass-ceramic composite which has a coefficient of thermal expansion potentially as low as ±0.02×10⁻⁶ K⁻¹ at room temperature. The plate 17 is adjustably and releasably mounted on the underside of the column by three substantially equidistantly spaced mounts 18 arranged around the circumference of the plate, thus at intervals of approximately 120°. The reference plane A passes substantially centrally through the plate, i.e. intermediate its two major faces, in the mounted position of the plate. The vitreous material plate which is structurally highly stable, but inherently fragile by comparison with the metallic materials otherwise employed in the column construction, is formed on its circumference with two machined faces 19 lapped to an optical flatness tolerance of λ/10, thus 69.3 nanometres, and plated to provide the desired level of reflectivity. The two faces 19 are located in mutually orthogonal planes which are, for preference, respectively at right angles to the two X and Y axial directions of the stage displacement, whereby the precondition is created for basing the optical measuring system on the same co-ordinate system of a further optical measuring system (not shown) for measuring and controlling the stage movement.

The two reflective or mirror faces 19 of the plate 17 respectively co-operate with two laser interferometry measuring systems each comprising a laser light emitter 20 emitting, in the plane A, a laser beam 21 which is directed onto and reflected by a respective one of the faces and from which, through interference of the emitted and reflected light, a measurement signal value indicative of the instantaneous face position in the respective axial direction (X or Y) can be derived and, for example, applied to a control component of the machine. The instantaneous positions of the faces 19 conjointly define a datum of the position of the lower end of the column 11 and, through comparison with a predetermined datum, permit recognition of shift in the column position in the sense of offset of the column axis 13 from its presumed static position in the reference plane A. The recognised shift forms the basis of the afore-mentioned data for use in influencing machine operation. It is not, however, necessary to process the data relating to the instantaneous face positions specifically for the purpose of recognising a shift in the column axis; it is equally possible, for example, to control machine components simply by reference to the instantaneous position of the axis, thus a floating datum.

Although a measuring system employing an integral vitreous material plate with machined reflective faces offers significant advantages with regard to structural and optical stability, the mounting of the plate 17 represents particular difficulties with regard to adjustment of the system, access to components at the base of the column for servicing or replacement, and preservation of the comparatively brittle material of the plate by avoidance of crack-inducing stresses. These problems are addressed by design of the mounts to permit adjustment of the plate 17, particularly tilt about its centre, removal of the plate to allow the desired access and retention of the plate in a manner avoiding local stresses. The mounts are additionally designed to enable quick and accurate recovery of the plate setting after the plate has been removed and refitted.

The mounts 18, which as mentioned are equidistantly spaced around the plate circumference, accordingly each comprise a plurality of interconnected elements permitting relative movement about mutually orthogonal axes parallel to the reference plane A. These elements consist, as shown in FIG. 3, of a fixing block 22 secured to the underside of the column 11 by way of screws 23 (indicated schematically) passing through vertical bores in the block, a first adjustable member 24 pivotably connected with the fixing block 22 and a second adjustable member 25 pivotably connected with the first member. The first member 24 has two lateral recesses leaving a central web 26 and the fixing block 22 has two projecting lugs 27 received in the recesses and extending on either side of the web. The pivotal interconnection of the block 22 and member 24 is by way of an axle pin 28 passing through the web and the lugs. The axle pin defines one of the two mutually orthogonal pivot axes extending parallel to the reference plane A and, in this instance, also parallel to a tangent to the circumference of the plate 17.

Determination of an adjustable and fixable setting of the first adjustable member 24 relative to the fixing block 22 is achieved by a screw adjuster in the form of a screw 29 extending with clearance through aligned bores in the block 22 and member 24 and threadedly engaged in a cross-bar 30 rotatably mounted in a transverse bore, which extends parallel to the axle pin 28, in the member 24. The member 24 is loaded, as evident from the following description, by the weight of the plate 17 which thus applies to the member 24 a moment tending to rotate the member about the axle pin 28 in clockwise sense in FIG. 3 and thus in the sense of causing the head of the screw 29 to bear against the base of an enlarged end section of the bore in which the screw extends. Tightening of the screw 29 thus draws the cross-bar 30 towards the block 22 and thereby pivots, under rotation of the cross-bar 30 in its bore, the member 24 in anti-clockwise sense in FIG. 3. Conversely, unscrewing the screw allows the member 24 to pivot in clockwise sense by virtue of the moment exerted by the plate 17. The threaded adjuster formed by the screw 29 and cross-bar 30 allows, with suitable thread pitch, fine adjustment of the angular setting of the first adjustable member 24. If the screw 29 is entirely unscrewed from the cross-bar 30, the member 25 is free to pivot in clockwise sense sufficiently to release the plate 17, as subsequently described. An established setting of the member 24 relative to the block 22 can be recorded by a datum pin 31 which is screwed into a threaded bore in the block 22 and contacts, by an end section protruding from the block, an adjacent face of the member 24. If the threaded adjuster 29, 30 has been operated to release the plate, the relative setting of the block 22 and member 24 can be recovered, at least to within a small tolerance, by screwing the screw 29 into the cross-bar 30 until the member 24 bears against the protruding end section of the datum pin 31, which thus functions as a stop. The stop also prevents, as explained further below, over-adjustment of the member 24 and consequential possible risk of damage of the plate 17.

The second adjustable member 25 consists of a body 32 from which an arm 33 extends in a direction away from the first member 24. The pivotable connection of the second member 25 with the first member 24 is realised by an axle pin 34 threadedly engaged in a bore in the first member 24 and freely rotatably engaged in a coaxial bore in the body 32 of the second member 25. The axle pin 34, which has a central collar seated in a recess in the member 24 and providing an enlarged bearing area for stability of these two components, defines the other one of the two mutually orthogonal pivot axes extending parallel to the reference plane A and, in this instance, radially with respect to the centre of the plate 17. The second member 25 is freely rotatable relative to the first member 24 so that adjustment of the position of the plate 17 by way of one of the threaded adjusters 29, of the mounts 18 can be accommodated at the other mounts without conflict and generation of local stresses.

In order to mount the plate 17 each arm 33 of the second adjustable member 25 of each mount 18 has a groove receiving two axially spaced rollers 35 (only one of which is visible in FIG. 3), by way of which a vertically directed clamping force, thus a force substantially perpendicular to the reference plane A, can be applied by the respective mount to clamp the plate against the underside of the machine. The clamping force exerted by each mount is accepted directly not by the fragile vitreous material of the plate 17, but by a respective insert 36 secured in a bore extending through the plate. Each insert 36 comprises an internally threaded sleeve 37 fixed in the plate by gluing, the sleeve having external grooves receiving adhesive, and an externally threaded bearing element 38 screwed into the sleeve and lockable therein in a selected axial position by a locknut 39. The bearing element 38 has at its lower end a flat head resting on the rollers 35 of the associated mount 18, whereby lineal contact between the mount 18 and the insert 36 is achieved. At its upper end the bearing element 38 has a part-spherical tip bearing against a seating body 40 threadedly mounted in the column 11 at its underside.

In a preferred arrangement, the bearing element 38 of a first one of the three mounts 18 bears against the walls of a V-shaped recess in the associated seating body 40 as illustrated in FIG. 3, but the element 38 of a second one of the mounts bears against the wall of a conical recess in the associated body 40 and the element 38 of the third one of the mounts bears against a flat face of the associated body 40, so to provide a low-friction kinematic mounting system in which the bodies 40 with the conical recess and flat face lie at a first radial spacing from the centre of the plate 17 and the body 20 with the V-shaped recess lies at a second, greater radial spacing from the centre. Rotation of the last-mentioned body 40 in its threaded mounting causes rotation of the plate 17 through, for example, a range of ±1° for fine adjustment of the perpendicularity of the faces 19 relative to the axes of the laser beams 21 in the sense evident from FIG. 2, the rotated body 40 then being fixed in its optimum setting.

The functioning of the arrangement for mounting the vitreous material plate 17 of the optical measuring system on the underside of the column 11 is largely self-evident from the foregoing explanation of the location and construction of the mounts 18 and the associated freedoms of movement of the components making up the mounts. Adjustment of the plate 17 so that, in particular, its reflective faces 19 are precisely normal to the reference plane A is achieved by way of the threaded adjusters 29, 30 of the mounts 18, i.e. screwing of the screws 29 into or out of the cross-bars 30 thereby to appropriately pivot the first adjustable members 24, and by way of the inserts 38 in the plate, i.e. screwing the bearing elements 38 up or down in the sleeves 37 thereby to raise or lower the associated edge regions of the plate. Orthogonality of the faces 19 with respect to the critical reference plane A may be achievable within a tolerance of approximately 5 microns. The free rotatability of the second adjustable members 25 of the mounts 18 relative to the first adjustable members 24, in particular about axes extending substantially radially of the plate, allows freedom of movement to accommodate tilting motion of the plate; the mounts effectively function as universal joints. Pivotable movement of the member 24 relative to the fixing block 22 of each mount is similarly accommodated by the clearance between the screw 29 and the walls of the associated bores and by rotation of the cross-bar 30 in the member 24. If the screws 29 are withdrawn entirely from the members 24, the members 24 and 25 of all mounts can be dropped down to free the plate 17 for removal so as to allow access to inter alia the sensitive final lens present in the base of the electron beam column and associated diodes and other electronic components susceptible to occasional failure. The previous settings of the mounts 18 and thus the setting of the plate 17 can be restored with the help of the datum pins 31 in the manner already described. The supplementary function of these pins as stops prevents over-tightening of the screws 29 and possible risk of cracking of the plate material.

Apart from adjustment to ensure orthogonality of the faces with respect to the plane A adjustment to ensure perpendicularity relative to the axes of the beam 21 in the plan aspect of the plate 17 is achievable, as described, by turning the seating body 40 with the V-shaped recess to impart rotational movement to the plate.

The invention thus provides an effective means of measuring undesired displacement of movement-sensitive equipment, exemplified in the described embodiment by an electron beam lithography machine, in a reference plane, the measuring means comprising an optical system based on laser interferometry and having a high level of optical accuracy and stability achieved by use of mirrors formed on an integral member of vitreous material with a low coefficient of thermal expansion. The disadvantages potentially arising from use of a member of such material are entirely or largely overcome by the special mounts allowing adjustment and removal of the member and fixing of the member by clamping forces oriented to avoid mechanically sourced stresses in the plate material.

1-30. (canceled)

31. Movement-sensitive equipment defining a reference plan and provided with an optical measuring system operable to measure the position of the equipment in the reference plane so as to detect unintended displacement of the equipment in that plane, the optical measuring system comprising:
means for providing measuring light beams;
an integral member of vitreous material provided with a plurality of reflective faces for reflecting the measuring light beams; and
a plurality of mounts adjustably and releasably mounting the member on the equipment substantially in the reference plane.

32. Equipment according to claim 31, wherein the mounts are adjustable in the sense of achieving orthogonality of the reflective faces relative to the reference plane.

33. Equipment according to claim 32, wherein the achievable orthogonality has a tolerance of substantially 5 microns.

34. Equipment according to claim 31, wherein the member of vitreous material is mounted on the equipment to be rotationally adjustable in the reference plan in the sense of achieving perpendicularity of the reflective faces relative to axes of the light beams.

35. Equipment according to claim 31, comprising three such mounts substantially equidistantly spaced around a periphery of the member of vitreous material.

36. Equipment according to claim 31, wherein each of the mounts fixes the member of vitreous material in position by clamping.

37. Equipment according to claim 36, wherein the direction of clamping action of each mount is oriented substantially exclusively perpendicularly to the reference plane.

38. Equipment according to claim 31, wherein each of the mounts has substantially lineal or punctiform contact with the member of vitreous material.

39. Equipment according to claim 38, wherein the substantially lineal contact is provided by a part-cylindrical surface.

40. Equipment according to claim 38, wherein the substantially punctiform contact is provided by a part-spherical surface.

41. Equipment according to claim 31, wherein the member has substantially lineal or punctiform contact with the equipment in the region of each mount.

42. Equipment according to claim 31, wherein the member is provided with a plurality of inserts each co-operable with a respectively associated one of the mounts and each having a resistance to fracture greater than that of the vitreous material of the member.

43. Equipment according to claim 42, wherein each of the inserts comprises a sleeve fixed in the member of vitreous material and a bearing element mounted in the sleeve to be adjustable substantially perpendicularly to the reference plan and arranged to bear against the associated mount.

44. Equipment according to claim 43, wherein the sleeve and bearing element of each insert are threadedly interengaged and the bearing element is adjustable by rotation.

45. Equipment according to claim 43, wherein the equipment is provided at a base thereof with a respective seat associated with the bearing element of each insert, the bearing element being additionally arranged to bear against the associate seat.

46. Equipment according to claim 45, wherein one of the seats is rotatable to impart to the associated bearing element a force tending to rotate the member of vitreous material in the reference plane.

47. Equipment according to claim 31, wherein each mount comprises two adjustable members each pivotable about a respective one of two substantially mutually orthogonal axes which are substantially parallel to the reference plane.

48. Equipment according to claim 47, wherein one of the two adjustable members of each mount is co-operable with the member of vitreous material and the axis of pivotation of that adjustable member extends substantially radially with respect to the centre of the member of vitreous material.

49. Equipment according to claim 48, wherein said one of the adjustable members of each mount is freely pivotable about its axis of pivotation.

50. Equipment according to claim 48, wherein each mount further comprises a fixing member and the other one of the two adjustable members of each mount is attached to a fixing member thereof to be pivotable about the respective axis of pivotation.

51. Equipment according to claim 50, wherein each of the mounts comprises position determining means for determining an adjusted position of said other one of the adjustable members of the mount relative to the fixing member of the mount.

52. Equipment according to claim 51, wherein the position determining means of each mount comprises a threaded adjuster operable to cause or allow pivotation of said other one of the adjustable members of the mount about the respective axis of pivotation.

53. Equipment according to claim 52, wherein the threaded adjuster of the position determining means of each mount is releasable to permit pivotation of said other one of the adjustable members of that mount for release of the plate.

54. Equipment according to claim 53, wherein each of the mounts comprises an adjustable datum pin for recording said determined adjusted position and maintaining that record while the threaded adjuster is released.

55. Equipment according to claim 31, wherein the reflective faces comprise two mutually orthogonal faces.

56. Equipment according to claim 31, wherein the means for providing the measuring light beams comprises lasers.

57. Equipment according to claim 56, wherein the equipment comprises a laser interferometry measuring system and the lasers are integrated therein.

58. Equipment according to claim 31, wherein the vitreous material has a substantially zero coefficient of thermal expansion at room temperature.

59. Equipment according to claim 31, wherein the equipment is part of an electron beam lithography machine.

60. Equipment according to claim 59, wherein the part of the machine is an electron beam column and the reference plane is at the base of the column and extends perpendicularly to a longitudinal axis of the column.
